(19) United States
(12) Patent Application Publication
(10) Pub. No.: US 2006/0171365 A1
(43) Pub. Date: Aug. 3, 2006

(54) Method and apparatus for L2TP dialout and tunnel switching

(75) Inventor: Michael S. Borella, Naperville, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Rolling Meadows, IL (US)

(21) Appl. No.: 11/049,540

(22) Filed: Feb. 2, 2005

(51) Int. Cl. H04Q 7/24

(52) U.S. Cl. 370/338

(57) ABSTRACT

Method and apparatus for establishing a tunnel between a mobile node and a routing device. The method includes the steps of utilizing the mobile node to place a call over a cellular network and gaining access to a foreign agent of the cellular network. A Mobile IP link is established between the foreign agent and a home agent and the call is authenticated. A tunnel is initiated between the home agent and the routing device and call data is tunneled between the home agent and the routing device.

### BACKGROUND

I. Field of the Invention

The present invention is directed to telecommunications. More particularly, the present invention is directed to methods and systems that dynamically establish Layer Two Tunneling Protocol (“L2TP”) sessions between a L2TP Access concentrator (“LAC”) and a L2TP Network Server (“LNS”). The invention is particularly useful in dynamically establishing L2TP sessions between a LAC and a LNS based on a triggered response. For example, such a triggered response could occur at the LAC. In one approach, the trigger can be an establishment of a tunneled mobile IP session at the LAC. Alternatively, the LAC may be a home agent. However, aspects of the invention may be equally applicable in other scenarios as well.

II. Description of Related Art

Virtual Private Network (“VPN”) services are generally prevalent in IP networks. One reason why VPN services are prevalent in IP networks is that VPN services offer secure remote access to corporate networks. Another reason for the prevalence of VPN services in IP networks is that VPN services offer secure trunking between offices and/or secure peer-to-peer communications. An emerging market for outsourced access technologies is currently planning on enhancing their offerings to include outbound VPN services.

For example, a nationwide cellular access provider may offer its access services to a corporation. In this manner, employees of the corporation that take advantage of these services may have wireless data access from virtually any location in the country. This provides certain advantages to both the nationwide cellular access provider as well as the corporation since the already established cellular infrastructure is generally cost prohibitive for a corporation to build out. Moreover, this scenario provides an advantage to the cellular access provider since the provider may now be able to sign on a group of users that could potentially turn out to be high-margin cellular access subscribers. Although it may be possible for a corporation to provide each employer a mobile device and then load each corporate employee mobile device with a VPN client and provision those mobile devices for secure VPN access over the cellular network to the corporation, this can turn out to be a significant operational expense. Such a scenario could also involve certain logistical and technical complications as well as corporate costs inefficiencies. For example, placing the VPN in the network removes a potentially expensive computational operation (e.g., encryption) from a mobile node, such as a mobile phone, a device that typically has a somewhat limited battery life.

As an alternative, and since the cellular service provider will have to provision the mobiles anyway, the cellular service provider can add VPN capabilities to a mobile device. However, if a mobile device establishes a VPN directly to the corporate VPN gateway, the cellular provider may be unable to provide additional value-added services on the user's data, since the data is encrypted. Additionally, the cellular provider may not be able to properly account and bill for the user's data if it is encrypted.

Moreover, there are a number of value-added services that a cellular provider may be able to provide corporate users. For example, a cellular access provider may be able to provide certain value-added services that include but are not necessarily limited to: content aware billing, application level compression, application aware quality of service, and per-user dynamic firewalls. Additionally, a service provider may not be able to easily adhere to legal requirements such as lawfully authorized electronic surveillance.

There is, therefore, a general need for a mobile IP home agent that can dynamically establish a tunneled session, such as an L2TP session, to a corporate enterprise. There is also a general need for a mobile IP home agent that can dynamically establish an L2TP session to corporate enterprises per user or per domain. There is also a general need for a method or system that establishes such an L2TP session based on certain policy considerations, such as a local policy or an authorization, authentication and accounting (“AAA”) server policy. In one approach, a table per mobile or per mobile domain (e.g., fedex.com) is established that indicates that when the mobile logs on to a Home Agent, a VPN should be automatically set up to an enterprise LNS.

### SUMMARY

In one aspect of the present invention, a method of establishing a tunnel between a home agent and a routing device includes the steps of receiving a Mobile IP request at the home agent from a foreign agent and authenticating the Mobile IP request. A tunnel is initiated between the home agent and the routing device. Call data is tunneled related to the Mobile IP request between the home agent and the routing device.

In another aspect, a system for establishing a tunnel between a home agent and a routing device includes a Mobile IP request transmitted from a foreign agent to the home agent. A server authenticates the Mobile IP request such that the tunnel is initiated between the home agent and the routing device. Call data related to the Mobile IP request is tunneled between the home agent and the routing device.

In yet another aspect, a method of tunneling a call between a first routing device and a second routing device includes the steps of receiving a tunneled packet on a first tunnel associated with a call at the first routing device. A local policy for the call is examined. The packet is then forwarded on a second tunnel to the second routing device.

### BRIEF DESCRIPTION OF THE DRAWINGS

Preferred embodiments of the present invention are described herein with reference to the drawings, in which:

FIG. 1 is a functional block diagram illustrating the movement of a mobile node from a home network to a foreign network;

FIG. 2 is a functional block diagram illustrating a triangular message pathway that results under Mobile IP for a message to a mobile node coupled to a foreign network;

FIG. 3 illustrates one arrangement of an RRQ;

FIG. 4 illustrates one arrangement of an RRP;

FIG. 5 illustrates one arrangement of a Layer Two Tunnel Protocol (L2TP) stack;

FIG. 6 illustrates one arrangement of an L2TP architecture;

FIG. 7 illustrates one arrangement of a preferred Attribute Value Pair (AVP) format for use with the L2TP architecture illustrated in FIG. 6;

FIG. 8 illustrates one arrangement of a preferred control packet format for use with the L2TP architecture illustrated in FIG. 6;

FIG. 9 illustrates one arrangement of a preferred data packet format for use with the L2TP architecture illustrated in FIG. 6;

FIG. 10 illustrates a state diagram for tunnel establishment and teardown of L2TP;

FIG. 11a illustrates an incoming call establishment state diagram from the LAC illustrated in FIG. 6;

FIG. 11b illustrates an incoming call establishment state diagram for the LNS illustrated in FIG. 6;

FIG. 12 illustrates a network architecture for L2TP dialout system;

FIG. 13 illustrates one arrangement of a call flow once an L2TP tunnel has been established;

FIG. 14 illustrates one arrangement of a call flow for outgoing call flow once an L2TP tunnel has been established; and

FIG. 15 illustrates one arrangement for mapping a Mobile IP stack and an L2TP stack.

### DETAILED DESCRIPTION

L2TP is a mechanism that enables automatic tunneling between a dialup user and a private network. L2TP may also be used to establish a VPN between two distinct IP networks connected by a third public network, such as the Internet. L2TP may be used alone or in conjunction with a VPN protocol such as IPsec, in order to provide this VPN. Unlike IP-in-IP tunneling, L2TP offers a number of advantages. For example, L2TP can encapsulate an entire PPP session within an X/IP/UDP session, where “X” represents a data-link protocol. L2TP also allows for negotiation of session parameters via a virtual control channel and provides sequence numbers and retransmission mechanisms for reliability, flow control, and congestion control. L2TP is also extensible via user-defined extension headers.

A current L2TP protocol is discussed and detailed in the document entitled “Layer Two Tunneling Protocol “L2TP”“, Network Working Group, Request for Comments: 2661, August 1999 which is herein entirely incorporated by reference and to which the reader is directed to for further information.

Background-Mobile IP

The Internet Protocol (“IP”) is an addressing protocol designed to route traffic within a network or between networks. The Internet Protocol is used on computer networks including the Internet, intranets and other networks. Internet Protocol addresses are typically assigned to “immobile” nodes on a network, and the IP address of each node is used to route datagrams to the node through a server connected to the node. An immobile node may be transferred to a different server on the computer network, but is typically associated with a static physical location.

In contrast, mobile nodes may connect to various physical locations on a computer network from various physical connections. A mobile node has its own network address and a semi-permanent relationship with a home agent or server to which the mobile node may occasionally be connected to send and receive datagrams. However, the mobile node can also connect to a home agent by way of a foreign agent through which it sends and receives datagrams. An example of one protocol that facilitates communication with mobile nodes over the Internet is the Mobile Internet Protocol (Mobile IP), which allows “mobile” nodes to transparently move between different Internet Protocol sub-networks (“subnets”). Mobile IP is described in Request for Comment (RFC) 2002, IP Mobility Support, C. Perkins, October 1996, herein incorporated by reference, available from the Internet Engineering Task Force (IETF) at www.ietf.org.

One version of the Mobile IP, Mobile IPv4, allows a mobile node (“MN”) to dynamically change its network connectivity in a manner that is transparent to layers above IP and the user. Under Mobile IPv4, MNs are assigned an IPv4 address on their home subnet (“HS”). This is the default subnet that the MN assumes that it is on unless the MN is informed otherwise. The HS is connected to an external network (e.g., the Internet) via a home agent (“HA”) that acts as the subnet's gateway router.

Internet Protocol addresses are typically assigned to mobile nodes based on their home Internet Protocol subnet. The home subnet is connected to an external network (e.g., the Internet or an intranet) with a “home agent” that may serve as the subnet's gateway router. As is known in the art, the gateway connects computer networks using different networking protocols or operating at different transmission capacities. A router translates differences between network protocols and routes data packets to an appropriate network node or network device.

When a mobile node “roams,” (i.e., dynamically changes its physical location, thereby altering its point of connection to the network), it periodically transmits “agent solicitation” messages to other gateway routers. A mobile node also listens for “agent advertisement” messages from other gateway routers. When a mobile node receives an agent advertisement message indicating that it is now on a foreign subnet, it registers with the foreign gateway router or “foreign agent” and its home agent. The registration with the home agent indicates that the mobile node is away from “home” (i.e., away from its home subnet). The registration with the foreign agent allows the mobile node to receive data on the foreign subnet.

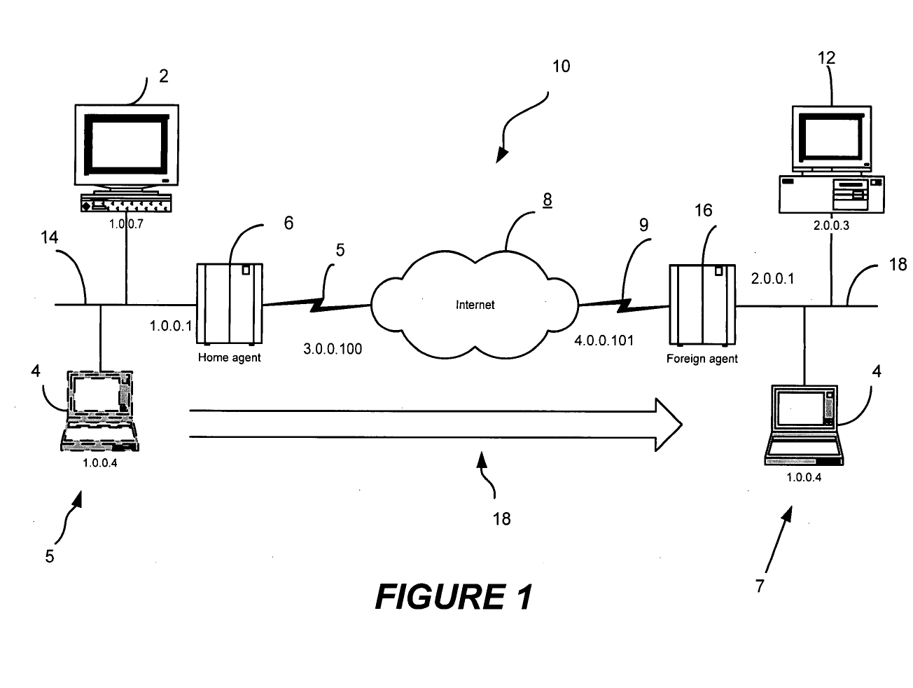

FIG. 1 shows an architecture 10 that illustrates an example of the connection of a mobile node (MN) 4 to the public IP network 8. This architecture 10 includes a MN 4 that roams from a first MN position 5 to a second MN position 7, a Home Agent 6, the public IP network 8, a first Foreign Agent 16, a Home Subnet 2 and a Foreign Subnet 12. The MN 4, host 1.0.0.4, belongs to the 1.0.0.0/24 Home Subnet (“HS”) 2 with Home Agent (“HA”) 1.0.0.1 6. The public IP network 8 includes a mobile node's home agent 6 and a foreign agent 16. The home agent 6 is coupled to the IP network 8 via a communication link 5 and has a globally routable network address of 3.0.0.100 on the network 8. The home agent 6 is also coupled to a local area network 14 that is the home subnet of the mobile node 4. The home subnet is 1.0.0.0/24. Other nodes are also connected to the home subnet 14, such as a node 2 with a globally routable network address of 1.0.0.7. The MN 4 has a globally routable IP address value of 1.0.0.4.

The foreign agent 16 is coupled to the IP network 8 via a communication link 7 and has a globally routable network address of 4.0.0.101 on the network 8. The foreign agent 16 is also coupled to a local area network (“LAN”) 18 that constitutes a foreign subnet to the MN 4. The subnet served by the foreign agent 16 is 2.0.0.0/24. Other nodes are also connected to the subnet 18, such as a node 12 with a globally routable network address 2.0.0.3.

As explained above, Mobile IP allows a mobile node to dynamically change its network connectivity in a manner that is transparent to layers above IP and the user. MNs are assigned an IP address on their home subnet, which is the default subnet for the MN unless the MN is informed otherwise. The home subnet is coupled to the IP network 8 via the home agent 6, which acts as the subnet's gateway router. When an MN 4 roams, e.g. moves to a service area or subnet 18 other than its home subnet 14 (as illustrated by arrow 18), MN 4 periodically transmits “agent solicitation” messages onto the subnet to which it is coupled and listens for an agent “advertisement message” from gateway routers. When the MN receives an agent advertisement message indicating that it is now on a different subnet, then it registers with the foreign gateway router.

For example, when the MN 4 connects to the LAN 14, it will transmit an agent solicitation message onto the LAN 14 that will be received by the foreign agent 16. Foreign agent 16 acts as a gateway router for the 2.0.0.0/24 subnet. The foreign agent 16 will respond by transmitting an agent advertisement message on the LAN 14 that will be received by the MN 4.

When the MN 4 receives the agent advertisement message from the foreign agent 16, MN 4 will register itself with foreign agent 16 and also with its home agent 6. When the MN 4 registers with the foreign agent 16, the foreign agent 16 will create a routing table entry for the network address 1.0.0.4 of the MN 4. The home agent 6 will also create a routing table entry for the MN 4 that includes the network address 4.0.0.101 for the foreign agent 16 to which the MN 4 is presently connected.

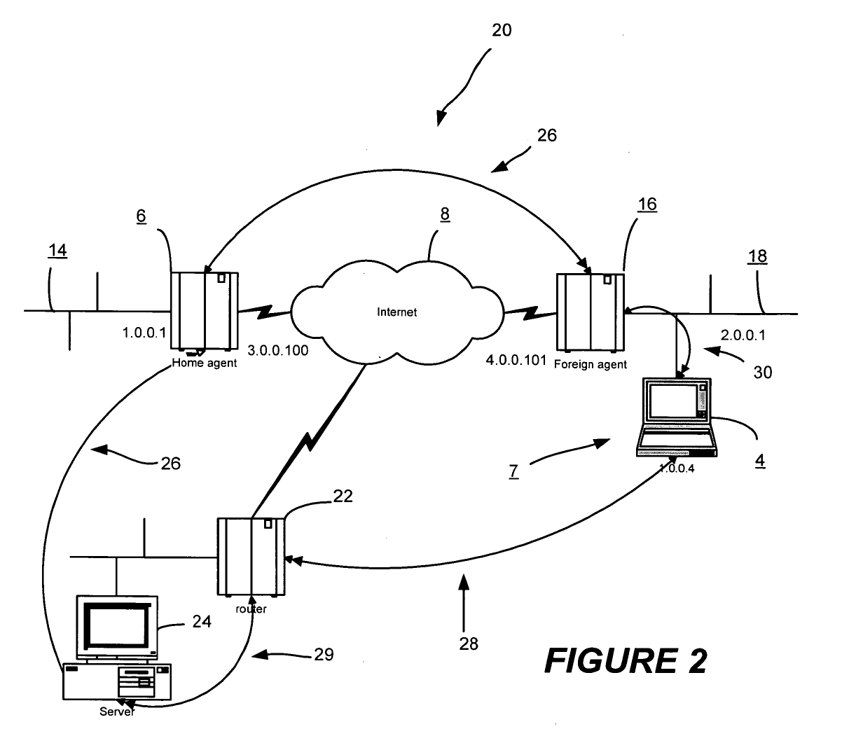

After registration has taken place, routing to the MN 4 is redirected from the home agent 6 to the foreign agent 16 identified in the registration, e.g. the redirect feature of Mobile IP. Round trip routing to and from MN 4 may be subsequently asymmetric. Routing between the MN and a server follows a triangular path between the server, the home agent 6 and the foreign agent 16. The architecture 20 of FIG. 2 illustrates this scenario. FIG. 2 is a functional block diagram illustrating a triangular message pathway that results under Mobile IP for a message to a mobile node coupled to a foreign network.

In the network 8, the home agent 6 is advertising itself as a route to the 1.0.0.0/24 subnet. Therefore, the home agent 6 will receive all packets addressed to the MN 4 with an address of 1.0.0.4. However, the MN 4 has registered with its current foreign agent 16, with the home agent 6. Therefore, when the home agent 6 receives a packet for the MN 4, e.g. a packet represented by arrow 26 from the server 24 in FIG. 2, the home agent 6 will tunnel the packet to the foreign agent 16, where the tunneled packet is represented by arrow 26. When the foreign agent 16 receives the tunneled packet 26, it strips off the outer IP headers corresponding to the tunnel and transmits the packet over the LAN 18 to the MN 4, as represented by arrow 30.

When the MN 4 transmits a packet, no tunneling or address translation is necessary. IP packets from the MN 4 are routed directly from the MN 4 through the foreign agent 16 to the external destination address on the IP network 8, as illustrated by arrows 208 and 209 for packets destined for the server 24. As will be explained, in Applicant's approach, traffic from a mobile node will be tunneled to a Home Agent for subsequent tunneling to a network enterprise.

In architecture 20, the MN 4, the foreign agent 16 and the home agent 6 maintain as little state information for the transaction as is possible. The MN 4 periodically transmits “keepalive” messages that inform the foreign agent 16 and the home agent 6 that it is still connected to the foreign agent's subnet. These updates are transmitted using Internet Control Message Protocol (ICMP) messages, see RFCs 792 and 2463 herein entirely incorporated by reference, some of which are standard ICMP messages and others that are unique to Mobile IP.

Standard Mobile IPv4 utilizes two messages for registration and various aspects of session maintenance. Other Mobile IPv4 messages may also be used. These two messages include a registration request message (“RRQ”) and a registration reply message (“RRP”). In one arrangement, an RRQ is sent from a MN to a FA and then on to a HA. The RRQ typically represents the MN asking the network to allow the MN to register (i.e., log on), or to extend an existing registration. For example, returning to the arrangement illustrated in FIG. 1, after MN 4 had roamed from its first position 5 to its second position 7, MN 4 would send an RRQ to FA 16. The RRQ would then be sent on to HA 6.

In reply to the RRQ, the HA creates a mobility binding record (MBR) for the mobile, which contains information that identifies the mobile (e.g., the mobile's assigned home address and network access identifier) and information that is associated with the mobile's session (e.g., the FA's care of address, GRE key, if applicable). The HA may also send an RRP to the FA to the MN. The RRP typically represents the network responding to the MN's RRQ, indicating that the MN is or is not allowed to register. Again, returning to the arrangement illustrated in FIG. 1, in reply to the RRQ sent by MN 4, an RRP would be sent from HA 6 to FA 16 and then to MN 4.

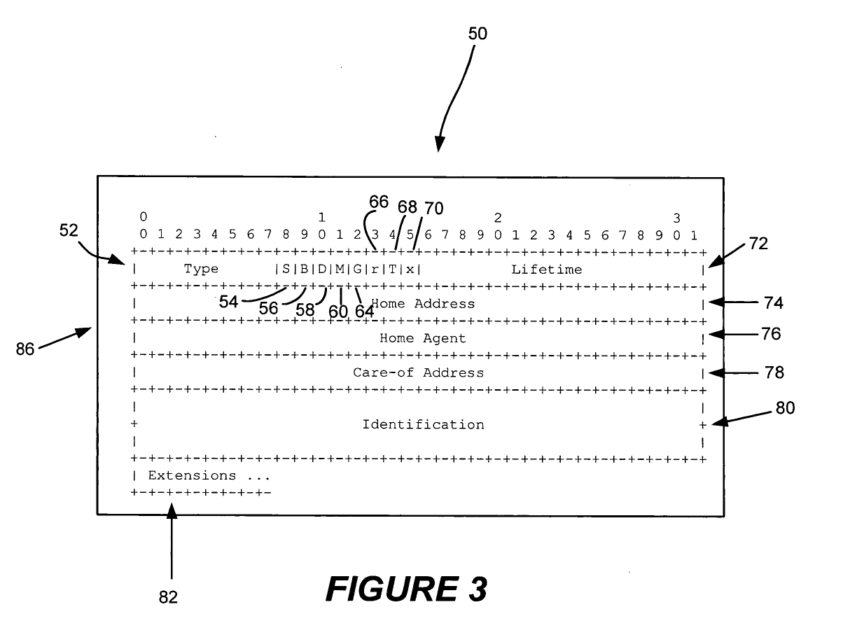

FIG. 3 illustrates one arrangement of an RRQ 50. RRQ 50 comprises a fixed portion 86 and extension 82. The fixed portion 86 comprises both a variety of data bits and various data fields. For example, the “Type” field 52 of RRQ format 50 designates a 1 (Registration Request) 52. RRQ 50 also includes an S bit 54 representing simultaneous bindings. If the ‘S’ bit 54 is set, a MN is requesting that is HA retain the MN's prior mobility bindings.

RRQ 50 also includes a “B” bit 56 which represents Broadcast datagrams. If the B bit 56 is set, the MN requests that the HA tunnel to it any broadcast datagrams that it receives on the home network. RRQ format 50 also includes a “D” bit 58 that represents Decapsulation by mobile node. That is, if the D bit 58 is set, the MN will itself decapsulate datagrams which are sent to the care-of address. That is, the MN is using a co-located care-of address. The mobile RRQ format 50 also includes an “M” bit 60 representing Minimal Encapsulation. If the ‘M’ bit 60 is set, the MN requests that the HA use minimal encapsulation for datagrams tunneled to the MN.

RRQ format 50 also includes a “G” bit 64 representing GRE encapsulation. GRE encapsulation provides a protocol for performing encapsulation of an arbitrary network layer protocol over another arbitrary network layer protocol. GRE encapsulation is described in Request for Comment (RFC) 1701, Generic Routing Encapsulation (GRE), S. Hanks, October 1994, herein incorporated by reference, available from the Internet Engineering Task Force (IETF) at www.ietf.org. If the G bit 64 is set, the MN requests that the HA use GRE encapsulation for datagrams tunneled to the MN. RRQ 50 also includes an “r” bit 66. The r bit 66 is sent as zero and is ignored upon reception. The r bit should not be allocated for any other uses.

RRQ 50 also includes a T bit 68. T bit 68 designates that Reverse Tunneling is requested. An x bit 70 is sent as zero and is ignored on reception. RRQ format 50 also includes a Lifetime data filed 72. Lifetime 72 represents the number of seconds remaining before the registration is considered expired. A value of zero indicates a request for deregistration. A Lifetime value of “0xffff” indicates infinity.

RRQ 50 also includes a Home Address field 74. Field 74 represents the IP address of the MN. RRQ 50 also includes a Home Agent field 76 that represents the IP address of the mobile node's home agent. The Care-of Address field 78 represents the IP address for the end of the tunnel. The Identification field 80 represents a 64-bit number that is constructed by the mobile node and is used for matching Registration Requests with Registration Replies. Identification field 80 is also used for protecting against replay attacks of registration messages.

And finally, the fixed portion 86 of Registration Request 50 is followed by one or more of Extensions 82. An authorization-enabling extension must be included in all Registration Requests since mobile IP traffic must be authenticated, otherwise a third party could disrupt a mobile IP call. Mobile IP has defined several authentication extensions in RFC 1701 such as, for example, MN-FA, FA-HA, and MN-HA. In addition, there is also the MN-AAA extension defined in Request for Comment 3012. Request for Comment (RFC) 3012, entitled Mobile IPv4 Challenge/Response Extensions, C. Perkins, November 2000, is herein entirely incorporated by reference and is available from the Internet Engineering Task Force (IETF) at www.ietf.org. The use of these extensions requires the provisioning of shared secrets between the two devices taking part in an authentication step.

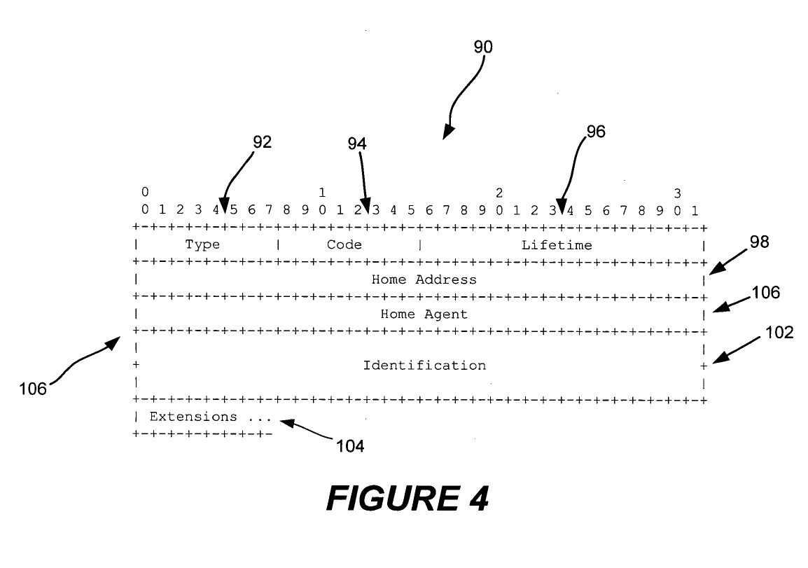

FIG. 4 illustrates an arrangement of a RRP 90. RRP 90 comprises a fixed portion 106 followed by Extensions 104. Fixed portion 106 includes various data bits and various data fields. For example, RRP 90 includes a first field Type: 3 (Registration Reply) that indicates that the message is an RRP. RRP 90 also includes a code field 94. Code field 94 represents a value that designates the result of the Registration Request. Provided below is a list of currently defined Code values.

RRP 90 includes a Lifetime field 96. If the Code field 94 designates that the registration was accepted, the Lifetime field 96 is set to the number of seconds remaining before the registration is considered expired. A Lifetime value of zero designates that the mobile node has been deregistered and a Lifetime value of “0xffff” designates infinity. If the Code field 94 designates that the registration was denied, the contents of the Lifetime field 96 will therefore be unspecified and therefore will be ignored on reception.

Home Address field 98 represents the IP address of the mobile node. The Home Agent field 100 represents the IP address of the mobile node's home agent. The Identification field 102 represents a 64-bit number that is used for matching Registration Requests with Registration Replies. Identification field 102 also is used to protect against replay attacks of registration messages. The value is based on the Identification field from the Registration Request message from the mobile node, and on the style of replay protection used in the security context between the mobile node and its home agent.

The fixed portion of the Registration Reply is followed by one or more extensions 104. An authorization-enabling extension must be included in all Registration Replies returned by the home agent.

LT2P

L2TP is a rapidly evolving mechanism that, among other features, enables automatic tunneling between dialup users and a private network. L2TP can also be used to establish a VPN between two distinct IP networks that are connected by a third public network.

L2TP offers a number of advantages over simple IP-in-IP tunneling. For example, L2TP encapsulates an entire PPP session within an X/IP/UDP session, where “X” is a data-link protocol. L2TP also allows for negotiation of session parameters via a virtual control channel. L2TP also provides sequence numbers and retransmission mechanisms for reliability, flow control, and congestion control. Alternatively, L2TP encapsulation can occur over a number of different packet-switched protocols that allow point-to-point delivery, such as ATM or Frame Relay virtual circuits. L2TP is also extensible via user-defined extension headers.

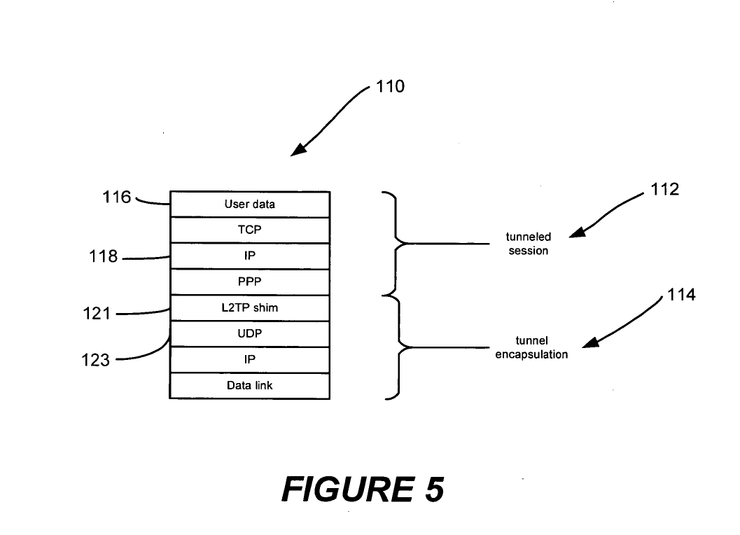

FIG. 5 illustrates an example of an L2TP protocol stack 110 for encapsulation of a TCP session over an IP network. L2TP stack 110 includes a tunneled session or call 112 and a tunnel encapsulation 114. Tunneled session 112 consists of user data 116 in a PPP/IP/TCP or PPP/IP/UDP packet 118. While L2TP is currently defined to use PPP to encapsulate the inner IP session, newer versions of L2TP may not require PPP.

PPP/IP/TCP packet 118 is encapsulated by an IP/UDP packet with an L2TP shim header 121 at the beginning of a UDP payload 123. L2TP Shim header 121 provides tunnel and session identification. Shim header 121 also provides a version number, sequence numbers, and other control information.

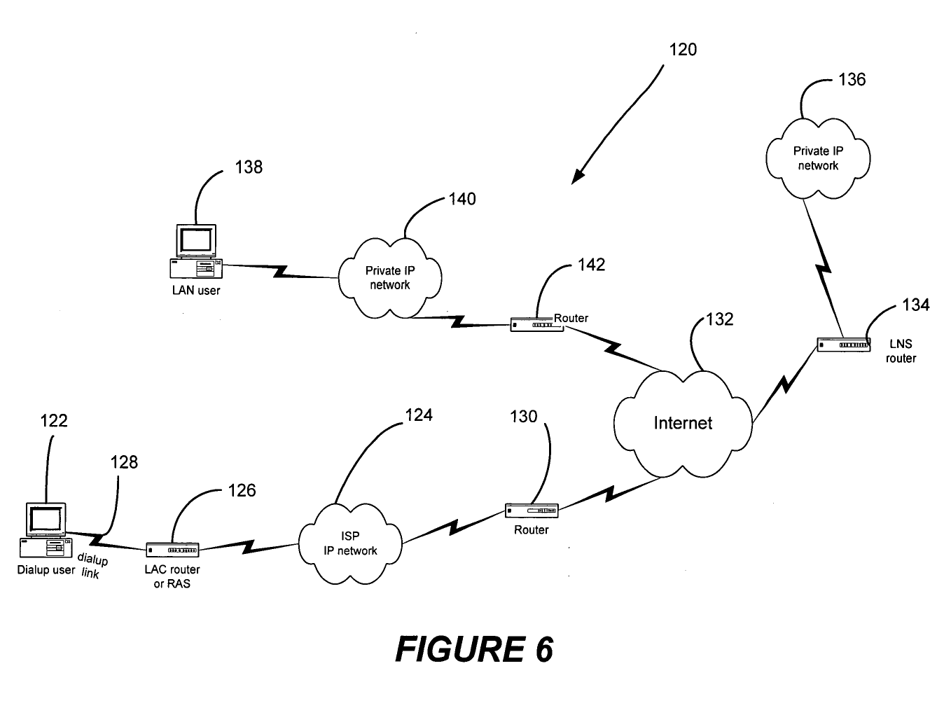

The architecture of a set of networks that may provide L2TP support to the users of some of these networks is illustrated in the network architecture 120 illustrated in FIG. 6. By way of example, and without limitation, architecture 120 illustrates essentially two different types of cases wherein L2TP may be used. Those skilled in the art will appreciate that the network architecture 120 illustrated in FIG. 6 is an example only, and does not represent the only arrangement or architecture in which the present approach of L2TP dialout and tunnel switching may be realized.

In the first case, dialup user 122 dials into an Internet Service Provider (“ISP”) 124 over dialup link 128 via LAC router or (“Remote Access Server”) RAS 126. ISP access router 126 serves as an L2TP Access Concentrator (“LAC”). Router 126 establishes an L2TP tunnel on behalf of the user 122 to the L2TP Network Server (“LNS”) 134 at a private IP network 136. LAC 126 determines the endpoint of the tunnel from a number of sources including dialup or caller ID.

For example, LAC 126 may determine the endpoint of a tunnel from a dialup user's authentication profile. Alternatively, LAC 126 determines the endpoint of the tunnel from an E.164 phone number.

A first authentication occurs where user 122 tunnels over LAC 126 to ISP IP network 124. LAC 126 then tunnels a user's PPP session via router 130 over Internet 132 to the LNS router 134 where authentication occurs a second time. LNS router 134 removes the L2TP and serves as a virtual access concentrator, terminating the user's PPP session. LNS router 134 authenticates a second session authentication dialup user 122 and provides dialup user 122 with an IP address from the private IP network's address space.

To dialup user 122, it may seem as if the user 122 is connected directly to private IP network 136. The case where dialup user 122 connects to LNS router 134 demonstrates how an individual (e.g., such as an employee working at dialup user 122) might telecommute from a remote office into a private network, such as an organization or a corporate private network.

In contrast to the first case illustrated in FIG. 6, another case may include both a first and a second private IP network. For example, the second case illustrated in FIG. 6 includes a system wherein an organization or company owns two private IP networks such as first private IP network 140 and the second private IP network 136. Private IP networks 140, 136 are coupled to the Internet 132. LAN user 138, and therefore first private network 140, is coupled to Internet 132 via an LAC router 142. LAC router 142 initiates and maintains an L2TP tunnel to LNS router 134 at the second private IP network 136. LNS router 134 couples Private IP network 136 to Internet 132. In this manner, traffic between first IP private network 140 and second private IP network 136 is tunneled over Internet 132.

In both the first and second tunneling systems generally described with respect to FIG. 6, encryption may be used to provide privacy across Internet 142. In addition, LAC router 142 and LNS router 134 functionality may be implemented on top of an existing router or access concentrator (modem pool) architecture. Alternatively, LNS router 134 (and perhaps LAC router 142) may be implemented as part of a firewall.

As will be understood by those of ordinary skill, more than one tunnel may be established between an L2TP Access Concentrator and an L2TP Network Server. L2TP tunnels may be controlled via a single control connection. Control connection for a given tunnel handles the setup, the modification, and the teardown of sessions (i.e., calls) within a given tunnel. Generally, a single L2TP Access Concentrator is associated with a particular call or session.

Alternatively, a dialup user, such as dialup user 122 shown in FIG. 6, may have multiple virtual connections to an LNS, wherein each of a user's connections designates a different call or a different tunnel. One of the advantages for multiple virtual connections is that these connections enable a user's voice and data session to have different quality of service parameters.

Packet Format

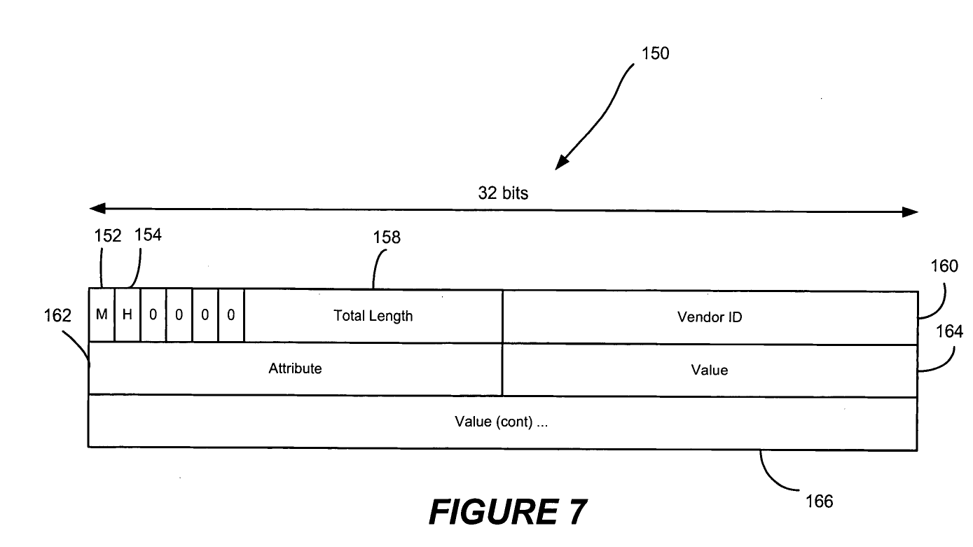

As described in the protocol “Layer Two Tunneling Protocol “L2TP” A. Valencia et al. herein incorporated entirely by reference and to which the reader is directed for further information, L2TP utilizes an Attribute-Value Pair (“AVP”) format. An AVP defines an attribute and the attribute's associated value. A single control packet may contain one or more AVPs. FIG. 7 illustrates an L2TP AVP format 150. As illustrated in FIG. 7, AVP format 150 has various data fields.

For example, the “M” field 152 of AVP format 150 designates a Mandatory bit (“M”). The Mandatory bit “M” determines the behavior of a call or a tunnel when an LAC or an LNS receives an AVP that the LAC or the LNS does not recognize. If M is set on an unrecognized AVP associated with an individual session (or call), the session is terminated.

If M is set to an unrecognized AVP associated with a tunnel, the entire tunnel will be terminated. If M is “0”, an LAC or LNS should ignore an unrecognized AVP. In general, a session, a call, or a tunnel is terminated with the M bit only if the unrecognized AVP is critical to the type of communication that will occur.

The AVP format 150 also includes an “H” field 154 which designates a Hidden bit. The Hidden bit controls the “hiding” of the value field. When an LAC and LNS have a shared secret, they may encrypt sensitive data, such as passwords, by performing a message digest (“MD”) hash function, such as an MD5 hash on the data. If such an MD5 hash is performed, the H bit is set. Further details of the MD5 hash are discussed in Valencia et al. previously incorporated entirely by reference and to which the reader id directed to for further information.

The Total Length field 158 designates the total number of bytes in the AVP. For AVPs defined by a private vendor, the vendor must place its IANA-assigned vendor ID code in the Vendor ID field 160. The Vendor ID field 160 allows extensibility and vendor-specific features.

The Attribute field 162 provides a code for the actual attribute, which must be unique with respect to the vendor ID. The Value field 164 encodes the value of the attribute. The length of Value field 164 is equal to the value of the total length field minus six.

In order to ensure flexibility and extensibility, L2TP utilizes an attribute-value pair (AVP) format within its control packets. An AVP defines an attribute and its associated value. A single control packet may contain one or more AVPs.

Control Packets

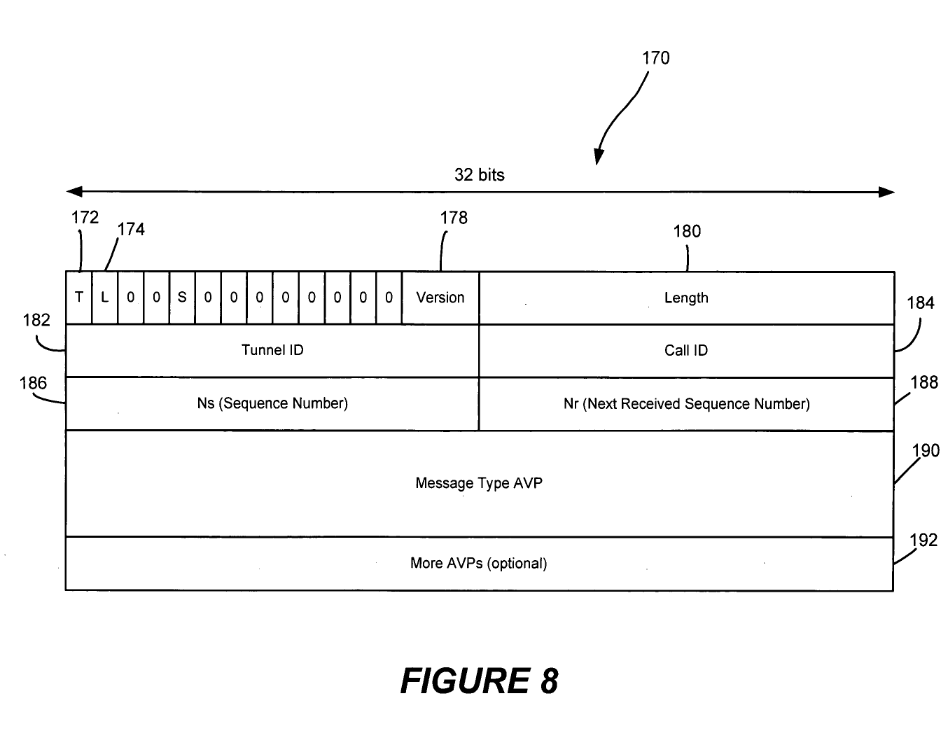

FIG. 8 illustrates a preferred L2TP control packet format 170 that can be utilized with AVP 150 of FIG. 7. Control packet format 170 consists of a 12-byte fixed header followed by a Message Type AVP. The Message Type AVP may be followed by other AVPs.

T field 172 designates a control packet. The L field 174 designates that the length field is present. The “F” field 172 designates that the sequence number fields are present. The version field 178 is preferably set to 2, the number 2 designating L2TP. The “Length” field 180 defines the total length of the control packet, including header and all AVPs. “Tunnel ID” field 182 defines the numeric tunnel identifier. “Tunnel ID” field 182 is set to zero if a tunnel is yet to be established. “Call ID” field 184 is a numeric call identifier. “Call ID” field 184 is set to zero if call is yet to be established.

The “Ns” or “Sequence Number” 186 field defines a packet's sequence number. The “Nr” or “Next Received Sequence Number” field 188 field defines the next sequence number that a sender expects to receive a packet with from a receiver. The “Message type AVP” field 190 is an AVP that describes the type of this message.

Control packets consist of a 12-byte fixed header followed by a Message Type AVP, which is then followed by zero or more AVPs 192.

Note that within the limits of the tunnel's MTU, as many AVPs as desired can be appended to control packets.

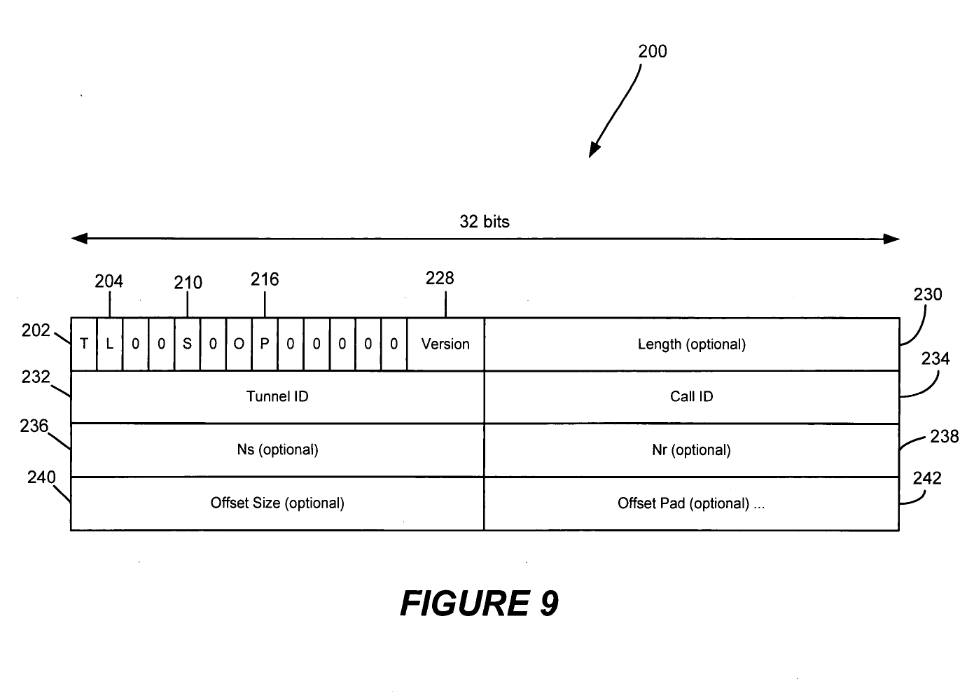

FIG. 9 illustrates an L2TP data packet format 200. In L2TP data packet format 200, the “T” field 202 indicates a data packet and is preferably zero. The “L” field 204 is set when the optional length field is present. The “R” field 206 signifies that the packet recipient should reset the received sequence number state variable to the value in the Ns field and must be zero if F is not set. The “F” field 208 is set when the optional sequence number fields are present. The “S” field 210 is set when the offset size field is present. If the “P” field 216 is set, this packet should be treated preferentially by the recipient. The “Version” field 228 is set to a value of 2, thereby indicating L2TP. The “Length” field 230 indicates the total length of the control packet, including header and all AVPs.

The “Tunnel ID” field 232 is a numeric tunnel identifier. The Tunnel ID field 232 is set to zero if tunnel is yet to be established. The “Call ID” field 234 is a numeric call identifier. The “Call ID” field 234 is set to zero if a call or tunnel is yet to be established.

The “Ns” field 236 is a packet's sequence number. The “Nr” field 238 is the next sequence number that a sender expects to receive a packet with from the receiver. The “Offset Size” field 24 is the number of bytes past the L2TP header at which the payload begins. The “Offset Pad” field 242 is preferably set to zeros.

Tunnel Establishment and Teardown

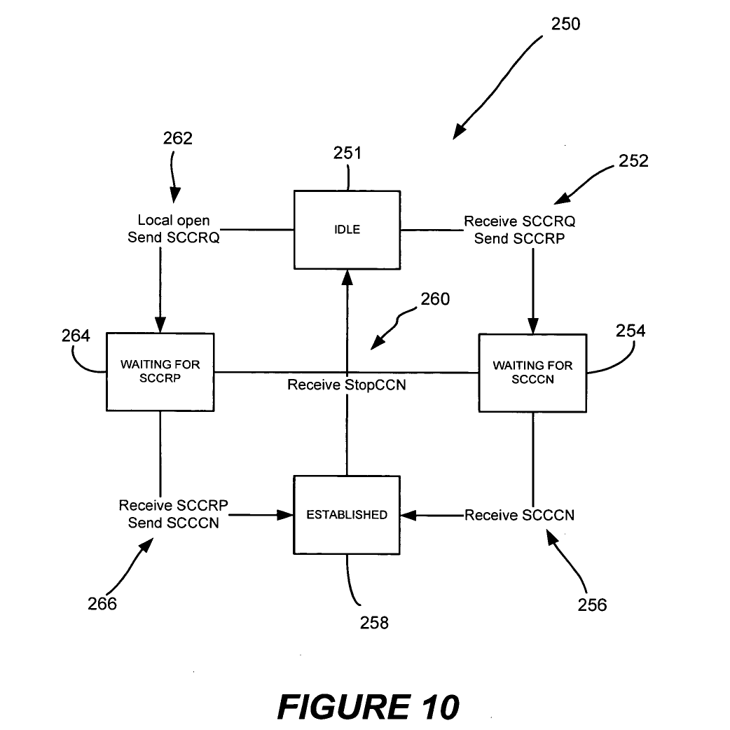

FIG. 10 illustrates a tunnel establishment and tunnel teardown state diagram 250. Either a sender of data or a receiver of data may initiate tunnel establishment. State diagram 250 utilizes the AVP, the control packet, and the data packet formats illustrated in FIGS. 7, 8, and 9, respectively. As shown in FIG. 10, L2TP tunnel establishment and teardown 250 is accomplished via a three-way handshake of various control messages. To accomplish the three-way handshake, a data sender (such as LAC 130 or 142 shown in FIG. 6) sends a Start-Control-Connection-Request (SCCRQ) message 252. A receiver (such as LNS 134 shown in FIG. 6) receives the SCCRQ 256 and responds with sending a Start-Control-Connection-Reply (SCCRP) message. Once the LAC receives the SCCRP, the LAC completes the handshake with a Start-Control-Connection-Connected (SCCCN) message 266. A tunnel is established once the SCCCN message is received 258.

The illustrations in state diagram 250 may also be used to exchange operating parameter information of the LAC and LNS, as defined by standardized AVPs. These messages may contain extension functionality with the use of additional AVPs.

In a TCP/IP network, such as network 120 illustrated in FIG. 6, the LNS default listen port is 1701. Preferably, a tunnel is established when an LAC transmits a UDP packet (usually an SCCRQ message) to an LNS listen port. The LAC and LNS may continue to communicate using port 1701. Alternatively, the LAC and LNS alter transmit and listen ports dynamically. Once a tunnel is established, tunneled sessions or “calls” may originate from either the LAC or the LNS.

An L2TP tunnel may be torn down from either the data receiving or the data originating source with the transmission of a Stop-Control-Connection-Notification (StopCCN) message 260. The recipient of a StopCCN message terminates all calls within the tunnel and cleans up tunnel state. No acknowledgment of or response to the StopCCN is transmitted to the originator of a message.

As referred to herein, sessions within an L2TP tunnel are referred to as “calls.” In one arrangement, a single tunnel may contain up to 2¹⁶-1 calls. Once an L2TP tunnel is established, L2TP control messages may be utilized by the LAC and LNS for the establishment and teardown of calls, as well as tunnel management and tunnel status.

Call Setup And Teardown

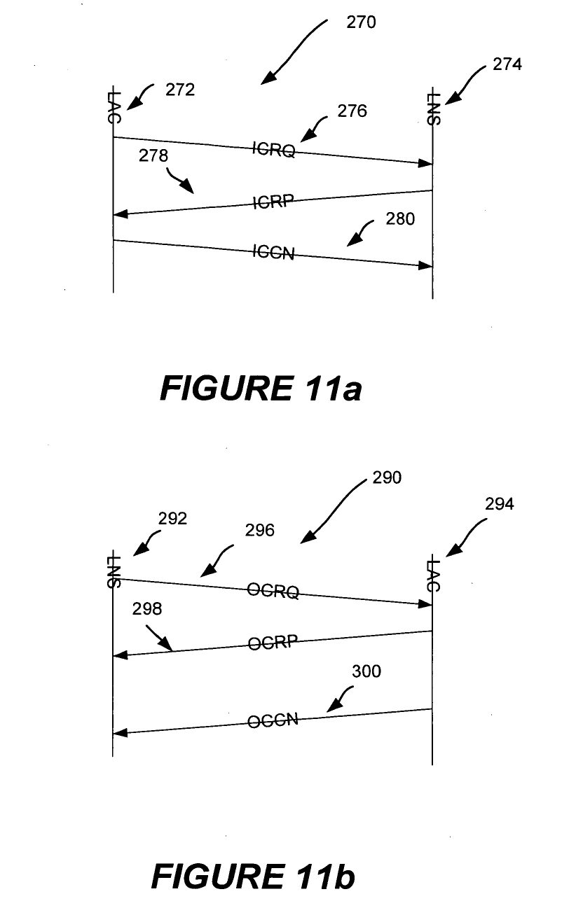

FIG. 11a illustrates an incoming call flow diagram 270 once an L2TP tunnel has been established. Flow diagram 270 establishes an incoming call between an LAC and an LNS, such as LAC 126, 142 and LNS 134 illustrated in FIG. 6. An incoming call (from LAC 272 to LNS 274) is established via a three-way handshake.

For example, LAC 272 transmits an Incoming-Call-Request (ICRQ) message 276 to LNS 274. LNS 274 receives the ICRQ and responds with an Incoming-Call-Reply (ICRP) message 278. LAC 272 receives ICRP 278 and completes the handshake with an Incoming-Call-Connected (ICCN) message 280. Aside from establishing the three-way handshake, messages 276, 278, and 280 may also be used to exchange information about caller identity and the capabilities of LAC 272 and LNS 274, as defined by standardized AVPs. Messages 276, 278, and 280 may also contain extension functionality with the use of additional AVPs.

FIG. 11b illustrates an outgoing call flow diagram 290 for establishing an outgoing call once a tunnel has been established. The outgoing call is established between an LAC and a LNS such as such as LAC 126, 142 and LNS 134 illustrated in FIG. 6. An outgoing call (from LNS 292 to LAC 294) is established via a two-way, three-message handshake. LNS 292 may initiate the outgoing call by initiating an Outgoing-Call-Request (OCRQ) message 296. LAC 294 receives OCRQ 296 and responds by transmitting to LNS 292 an Outgoing-Call-Reply (OCRP) message 298. LAC 294 completes the handshake by transmitting an Outgoing-Call-Connected (OCCN) message 300 once a recipient of the call picks up the line. Messages 296, 298, and 300 are used to exchange information about caller identity and the capabilities of the LAC and LNS, as defined by standardized AVPs. Messages 296, 298, and 300 may also contain extension functionality with the use of additional AVPs.

Once an outgoing call is established, a Set-Link-Info (SLI) message may be transmitted from the LNS to the LAC to re-negotiate call parameters. The SLI message may only re-negotiate PPP parameters as described in the L2TP RFC. However, by utilizing additional AVPs, an SLI message may be used to modify arbitrary call parameters.

Once a call has been established, the call may be torn down from either the LAC or LNS with the transmission of a Call-Disconnect-Notify (CDN) message. Upon receiving a CDN message, a party that receives the CDN message terminates the call and clean up call state. No acknowledgment of or response to the CDN message is sent to the originator of the message.

LT2P DIALOUT

By combining features of a mobility-based protocol with the L2TP architecture, the L2TP architecture may be modified to provide novel methods and systems for L2TP dialout and tunnel switching. In one embodiment, a mobile node places a call that is received by a foreign agent. Home agents are used to receive RRQ's from these foreign agents. The home agent optionally exchanges messages with an authorization, authentication and accounting (“AAA”) server to authenticate the call. A dialout policy may be used to facilitate this authentication step. According to an exemplary embodiment, the Mobile IP architecture is mapped onto a tunneling architecture, such as the standard L2TP architecture illustrated in FIG. 5, and a tunneling session is established between the home agent and a Local Network Server. Once the tunneling negotiation has been completed, the home agent sends the foreign agent an RRP.

Due to the fact that many corporations and enterprises use L2TP for VPN remote access, wireless mobile IP services that are sold to enterprises by wireless service providers can add value by initiating L2TP tunnels to the enterprise from the home agent. Using the home agent for this service ensures that IP mobility will still take place, but the user data will not cross a public network unprotected.

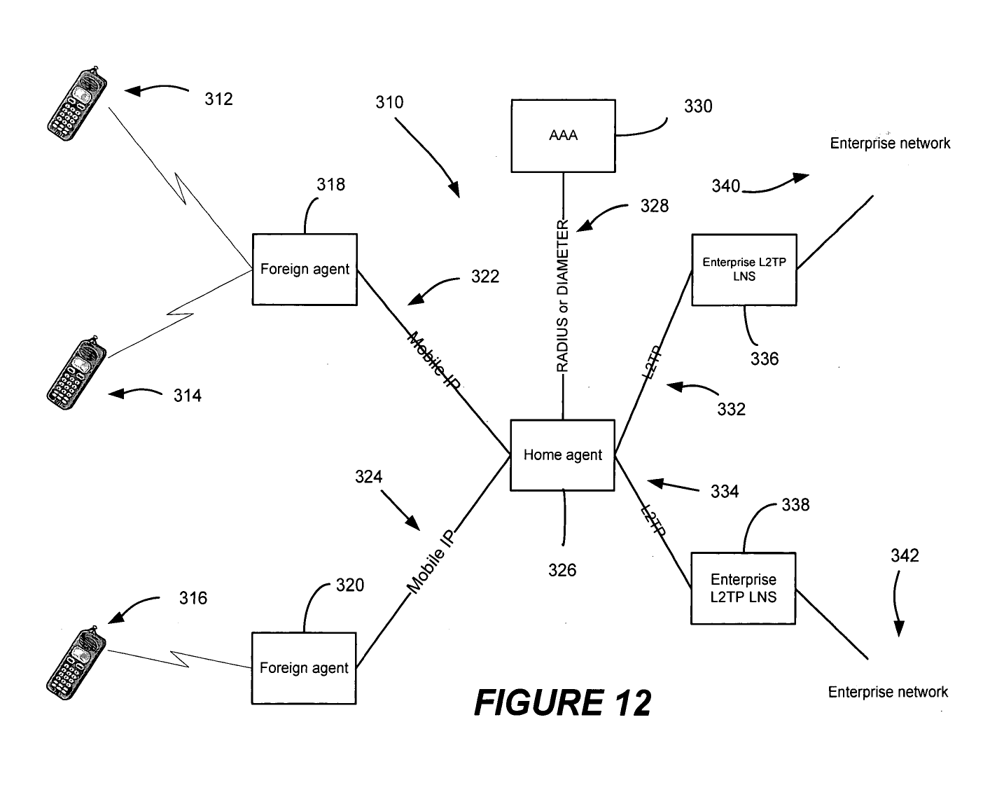

A key component for such an L2TP dialout system for VPN remote access is shown in the network architecture 310 illustrated in FIG. 12. Architecture 310 includes a plurality of mobile nodes 312, 314, and 316 (e.g., mobile phones), a first and a second Foreign Agent 318, 320, a Home Agent 326, a AAA 330, and a plurality of Enterprise L2TP LNSs 332, 338. Each Enterprise L2TP LNS 336, 338 is coupled to an Enterprise Network 340 or 342.

Mobile subscribers 312, 314, and 316 use a wireless service provider's cellular network to gain access to a foreign agent. For example, mobile subscribers 312 and 314 access FA 318 while mobile subscriber 316 accesses FA 320. Via mobile IP, FA 318 establishes a tunnel 322 to HA 326. Likewise, FA 320 establishes a tunnel 324 via mobile IP to HA 326. HA 326 then accesses AAA via Radius or Diameter 328 to authenticate a call or session.

RADIUS is an authentication, authorization and accounting protocol that is defined primarily in RFCs 2865 and 2866. When a client node logs on to a remote access server (such as an FA or and HA), the remote access server may access a Remote Authentication Dial In User Service (“RADIUS”) server to authenticate the node and furthermore may periodically send accounting records to the RADIUS server. These messages adhere to the RADIUS protocol. The RADIUS protocol for carrying authentication, authorization, and configuration information between a Network Access Server that desires to authenticate its links and a shared Authentication Server is described in Request for Comment (RFC) 2865, Remote Authentication Dial In User Server (RADIUS), C. Rigney, June 2000, herein entirely incorporated by reference and is available from the Internet Engineering Task Force (IETF) at www.ietf.org.

DIAMETER is another AAA protocol that largely accomplishes the same functions as RADIUS but has more robust behavior in the presence of network or device failure. The DIAMETER protocol herein entirely incorporated by reference and is available from the Internet Engineering Task Force (IETF) at www.ietf.org.

When HA 326 accesses AAA 330 in order to authenticate a session, AAA 330 may return an indicator that the user's session should be reflexively sent over and L2TP tunnel to a particular enterprise LNS. Alternatively, HA 326 may be statically configured to perform the tunneling based on a user's Network Access Identifier (“NAI”), user's domain, or an assigned IP address. The NAI comprises an identifier such as “server-a.xyz.com” and is a globally unique name.

Certain information can be configured either on the HA or on the AAA, per each enterprise. Such information may be used to configure a dialout policy. For example, such information should include an identification or listing of one or more Enterprise L2TP LNS's. Other information that can be configured includes the type of tunnel that can be established between the HA 326 and the Enterprise L2TP LNSs 336, 338. That is, specific information relating to L2TP, IPsec/L2TP, or other types of tunnel configurations may also be configured.

Other information could include the type of IP pool. Such an IP pool could belong to the enterprise rather than the service provider. Typically, the home agent assigns an IP address to a mobile node from one of its pools. These pools usually consist of IP addresses owned by the service provider. In a present approach, an IP pool used by an enterprise user can various forms. For example, the IP pool may be (1) owned by the service provider but dedicated to a particular enterprise, or (2) owned by the enterprise and used by the home agent to assign IP addresses to mobiles associated with that enterprise. Alternatively, the IP address may be assigned by an LNS rather than an HA. Taken either together, or in part, the enterprise configuration data and/or information may be generally referred to as a dialout policy.

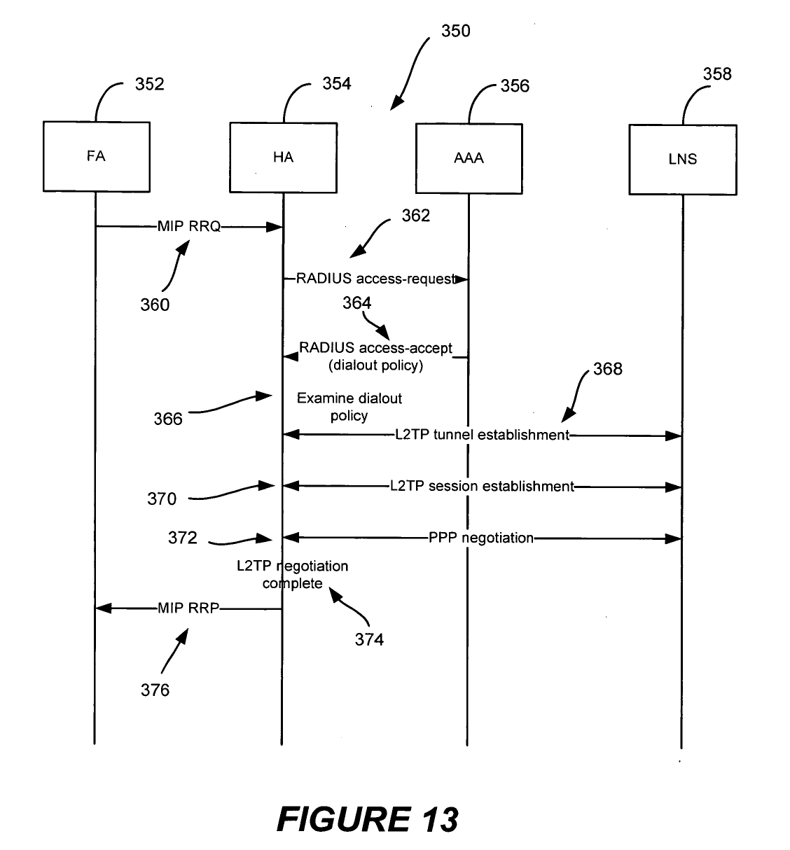

These procedures are illustrated in two exemplary L2TP call flow diagrams. For example, FIG. 13 illustrates a first exemplary L2TP call flow diagram 350 for initially establishing an L2TP call where an L2TP session has not already been established. Call flow 350 includes a foreign agent (“FA”) 352, a home agent (“HA”) 354, an authorization, authentication and accounting (“AAA”) server 356, and an LNS 358. In L2TP call flow 350, L2TP session establishment is shown using a dialout policy returned from AAA 356, where an L2TP tunnel does not already exist between HA 354 and LNS 358. In FIG. 13, a dialout policy 366 is locally configured on HA 354. However, as those of ordinary skill will recognize, other dialout policies and dialout configurations are also possible.

Call flow 350 begins when FA 353 sends a MIP RRQ message 360 to HA 354. MIP RRQ message could be similar to the RRQ message illustrated in FIG. 3. HA 354 then preferably sends a RADIUS access-request message 362 to AAA 356.

AAA server 356 then preferably sends a RADIUS access-accept message 364 to HA 354. After receiving RADIUS access-accept message 364, HA 354 examines a dialout policy 366. After examination of dialout policy 366, a L2TP tunnel is established between HA 354 and LNS 358. Subsequently, a L2TP session is established 370 between HA 354 and LNS 358. HA 354 and LNS 358 then commence PPP negotiation 372. After L2TP negotiation is complete 374, HA 354 enters the associated L2TP information (including the LNS IP address, call ID and session ID) into the mobile's MBR and sends an MIP RRP message 376 to FA 352. MIP RRP message could be similar to the RRP message illustrated in FIG. 4. MIP RRP message 376 may be returned earlier in the call flow diagram 350 if an IP address is locally assigned. Returning MIP RRP message earlier in call flow diagram 350 allows a Home Agent to indicate that a mobile IP session has been successful even before a L2TP tunnel setup has been completed. Note that in call flow the IP address assigned to the mobile can be determined by the HA or the LNS. If the HA is configured to provide the IP address, it will negotiation the mobile's IP address with the LNS using PPP's IPCP phase,

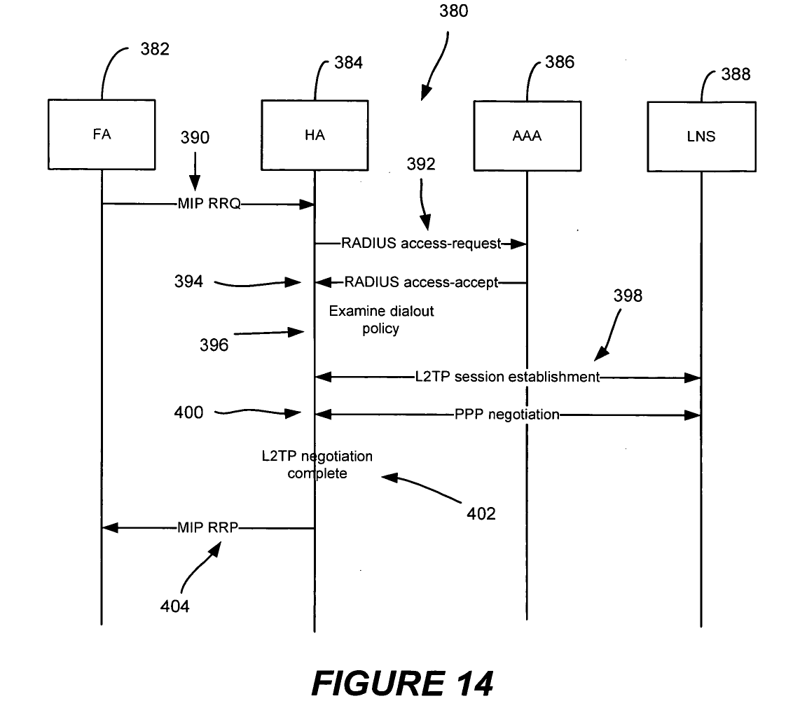

FIG. 14 illustrates an exemplary L2TP call flow 380 wherein a L2TP session has already been established. In FIG. 14, a dialout policy 396 is locally configured on HA 384. Call flow 380 includes a foreign agent (“FA”) 382, a home agent (“HA”) 384, a AAA 386, and an LNS 388. In L2TP call flow 380, L2TP session establishment is shown using dialout policy returned from the AAA, where an L2TP tunnel already exists between HA 384 and LNS 388. Call flow 380 begins when FA 382 sends a MIP RRQ message 390 to HA 384. HA 384 then sends a RADIUS access-request message 392 to AAA 386. AAA 386 then sends a RADIUS access-accept message 394 to HA 384.

After receiving RADIUS access-accept message 394, HA 384 examines dialout policy 396. After examination of dialout policy 396, a L2TP session is established 398 between HA 384 and LNS 388. HA 384 and LNS 388 then commence PPP negotiation 400. After L2TP negotiation is complete 402, HA 384 sends an MIP RRP message 404 to FA 382. MIP RRP message 404 may be returned earlier in call flow diagram 380 if an IP address is locally assigned.

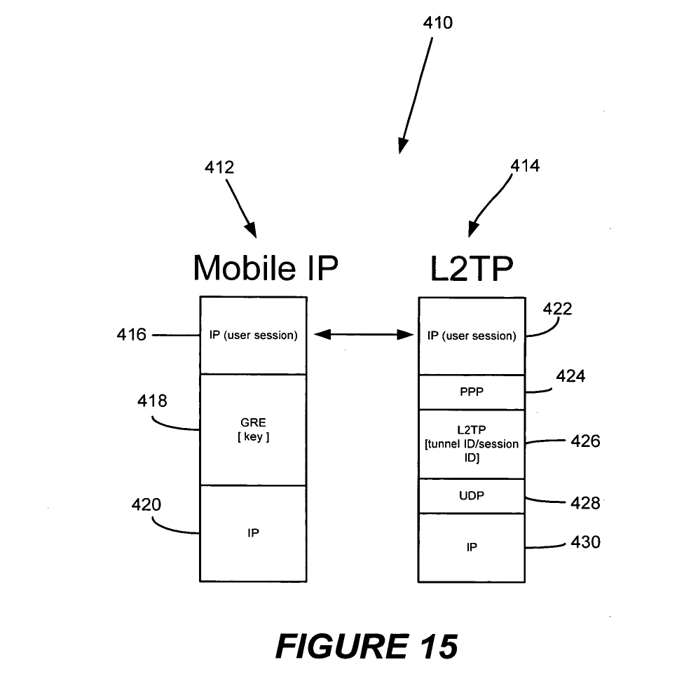

User data is tunneled over the session once the session is established. In the forward (enterprise to mobile) direction, the outer IP header, L2TP and PPP headers are stripped off, and the remaining IP packet is encapsulated in GRE or IP to be sent down the Mobile IP tunnel. In the reverse (mobile to enterprise) direction, the outer IP and GRE (if present) headers are stripped off and the packet is placed in the appropriate L2TP session. Fast tunnel switching can occur by mapping the L2TP tunnel ID and session ID to the Mobile IP GRE key in the forward direction and performing the opposite mapping in the reverse direction. FIG. 15 illustrates how this L2TP to Mobile IP GRE mapping may be accomplished. The GRE key can be uniquely mapped to a tunnel ID/call ID and vice versa. This facilitates packet processing by allowing the data plane of the session to be processed as follows: For a forward direction packet, the outer IP header, UDP header, L2TP header and PPP header are stripped off. The HA maps the L2TP call ID and session ID to a GRE key by examining the mobile's MBR. The information associated with the mobile IP session is used to create the GRE header and IP header of the IP packet that is sent from the FA to the HA. For a reverse direction packet, the outer IP header and GRE header are stripped off and the mobile's home address and GRE key are used to look up the associated L2TP session in the mobile's MBR. Once the L2TP session is identified, the HA created the outer IP header, UDP header, L2TP header and PPP header from the information retrieved from the MBR and sends the tunneled packet to the LNS.

Preferred embodiments of the present invention have been described herein. It will be understood, however, that changes may be made to the various features described without departing from the true spirit and scope of the invention, as defined by the following claims.

I claim:

1. A method of establishing a tunnel between a home agent and a routing device, said method comprising the steps of:
receiving a Mobile IP request at said home agent from a foreign agent;
authenticating said Mobile IP request;
initiating said tunnel between said home agent and said routing device; and
tunneling call data related to said Mobile IP request between said home agent and said routing device.

2. The invention of claim 1 further comprising the step of
establishing a tunneling session between said home agent and said routing device.

3. The invention of claim 1 further comprising the step of
authenticating said request by accessing a server.

4. The invention of claim 1 further comprising the step of
authenticating said request by monitoring a dialout policy.

5. The invention of claim 4 wherein said dialout policy is configured on said home agent.

6. The invention of claim 4 wherein said dialout policy is based on an identity of a mobile node.

7. The invention of claim 6 wherein said identity of said mobile node comprises a network access identifier (“NAI”).

8. The invention of claim 4 wherein said dialout policy is configured on a server.

9. The invention of claim 8 wherein said server comprises an AAA server.

10. The invention of claim 4 wherein said dialout policy is configured on said routing device.

11. The invention of claim 1 further comprising the step of
providing an indicator that call data related to said Mobile IP request is to be tunneled to a particular routing device.

12. The invention of claim 1 wherein said routing device comprises an enterprise Local Network Server.

13. The invention of claim 11 further comprising the step of
utilizing a server to provide said indicator that call data related to said Mobile IP request be tunneled to a particular routing device.

14. The invention of claim 1 wherein said home agent is configured to perform tunneling based on an NAI of a mobile node.

15. The invention of claim 1 wherein said home agent is configured to perform tunneling based on a domain of a mobile node.

16. The invention of claim 1 wherein said home agent is configured to perform call tunneling based on an assigned IP address of a mobile node.

17. The invention of claim 1 further comprising the step of communicatively coupling said routing device to an enterprise network.

18. The invention of claim 1 wherein said tunnel comprises an L2TP tunnel.

19. The invention of claim 1 further comprising the step of
utilizing a mobile node to place a call over a cellular network to said foreign agent.

20. The invention of claim 19 further comprising the step of
establishing a Mobile IP tunnel between said foreign agent and said home agent.

21. The invention of claim 20 further comprising the step of
commencing PPP negotiation between said home agent and said routing device.

22. The invention of claim 21 further comprising the step of
sending a Mobile IP registration reply message after PPP negotiation between said home agent and said routing device is completed.

23. The invention of claim 1 wherein said routing device comprises a L2TP Network Server.

24. A system for establishing a tunnel between a home agent and a routing device, said system comprising:
a Mobile IP request transmitted from a foreign agent to said home agent;
a server to authenticate said Mobile IP request such that said tunnel is initiated between said home agent and said routing device; and
call data related to said Mobile IP request tunneled between said home agent and said routing device.

25. The invention of claim 24 further comprising a tunneling session established between said home agent and said routing device.

26. The invention of claim 24 further comprising a dialout policy that is monitored to authenticate said request.

27. The invention of claim 26 wherein said dialout policy is configured on said home agent.

28. The invention of claim 26 wherein said dialout policy is based on an identity of a mobile node.

29. The invention of claim 28 wherein said identity of said mobile node comprises a network access identifier (“NAI”).

30. The invention of claim 26 wherein said dialout policy is configured on said server.

31. The invention of claim 26 wherein said server comprises an AAA server.
The invention of claim 24 further comprising an indicator that call data related to said Mobile IP request is to be tunneled to a particular routing device.

32. A method of tunneling a call between a first routing device and a second routing device, said method comprising the steps of:
receiving a tunneled packet on a first tunnel associated with a call at said first routing device;
examining local policy for said call; and
forwarding said packet on a second tunnel to said second routing device.

33. The invention of claim 32 wherein said first tunnel comprises a generic routing encapsulation tunnel.

34. The invention of claim 32 wherein said first tunnel comprises an IP-in-IP tunnel.

35. The invention of claim 32 wherein said second tunnel comprises an L2TP tunnel.

36. The invention of claim 32 further comprising the step of
encapsulating a portion of said packet before forwarding said packet on said second tunnel to said second routing device.

37. The invention of claim 32 wherein said encapsulating step comprises an L2TP encapsulation.

38. The invention of claim 32 wherein said encapsulating step comprises a GRE encapsulation.

39. The invention of claim 32 wherein said encapsulating step comprises an IP encapsulation.
